(19) United States
(12) Patent Application Publication
(10) Pub. No.: US 2004/0215556 A1
(43) Pub. Date: Oct. 28, 2004

(54) Marketing of an agricultural input via electronic communications

(76) Inventors: John Eugene Merkley JR., West Des Moines, IA (US); Sheila Denise Jesse Oliver, West Des Moines, IA (US); Greg Alan Unruh, Clive, IA (US); Roby Christian Shay, Urbandale, IA (US); Timothy Dale Unruh, Urbandale, IA (US); Daniel Michael DaLuga, Urbandale, IA (US); David Michael Kahle, West Des Moines, IA (US); Matthew Lowell McBurney, West Des Moines, IA (US); Troy Edward Swigert, West Des Moines, IA (US); Ronald Kelly Tisdell, Plano, TX (US); Randy Allen Van Essen, Otley, IA (US); Kelly Ann Foster, Johnston, IA (US)

Correspondence Address: Darin E. Bartholomew, c/o Deere & Company, One John Deere Place, Moline, IL, 61265-8098, US

(21) Appl. No.: 10/754,218

(22) Filed: Jan. 9, 2004

Related U.S. Application Data
(60) Provisional application No. 60/439,572, filed on Jan. 10, 2003.

(51) Int. Cl. G06F 17/60

(52) U.S. Cl. 705/38

(57) ABSTRACT

A method and system of marketing an agricultural input via electronic communications obtains retailer information and product information associated with a corresponding retailer. Available programs (e.g., financial incentive programs) are established for the retailer based on at least one of the retailer information and product information. An agricultural input is selected and marketed to a filtered prospect list based upon one or more of the following indicators: estimated current purchase data for the agricultural input for a particular corresponding prospect, current crop risk analysis for a particular corresponding prospect, and a crop identifier for a particular corresponding prospect. The selected agricultural input is associated with one or more of the available programs. A financial analysis tool facilitates the evaluation of the extension of credit or lending to any prospect on the filtered prospect list that seeks to participate in an available program associated with the selected agricultural input.

This document claims priority based on U.S. Provisional Application 60/439,572, filed Jan. 10, 2003, and entitled INTEGRATED FINANCIAL PROCESSING SYSTEM AND METHOD FOR FACILITATING AN INCENTIVE PROGRAM, under 35 U.S.C. 119(e).

### FIELD OF THE INVENTION

This invention relates to a method and system for marketing an agricultural input via electronic communications.

### BACKGROUND OF THE INVENTION

Retailers or other sellers may offer agricultural inputs to growers or producers. Agricultural inputs include, but are not limited to, seed, chemicals, fertilizer, feed, medicine, or other inputs that used in the production of agricultural products, food or in the raising of livestock. Retailers or other sellers may experience delays and higher transaction costs than desired in arranging financing for prospects or customers via traditional paper loan applications. For example, first, workers of the retailers may collect loan application information from prospects in a personal interview with prospects; second, the workers communicate the collected information with a credit bureau, financial institutions or other lenders via phone calls or facsimile transmissions; and third, the workers determine the creditworthiness or financial suitability of prospects or customers prior to entering into a transaction for the sale of agricultural inputs to reduce risks.

Although retailers may desire to market specialized agricultural inputs with different genetic traits or attributes depending upon grower requirements, maintaining an inventory of specialized agricultural inputs may detract from the retailer's financial performance. Thus, a need exists for marketing agricultural products in conjunction with screening prospects for creditworthiness or suitability. Further, a need exists for estimating the potential need for forecasted quantities of particular agricultural inputs for inventory planning of the retailers.

### SUMMARY OF THE INVENTION

A method and system of marketing an agricultural input via electronic communications obtains retailer information and product information associated with a corresponding retailer. Available programs (e.g., financial incentive programs) are established for the retailer based on at least one of the retailer information and product information. An agricultural input is selected and marketed to a filtered prospect list based upon one or more of the following indicators: estimated current purchase data for the agricultural input for a particular corresponding prospect, current crop risk analysis for a particular corresponding prospect, and a crop identifier for a particular corresponding prospect. The selected agricultural input is associated with one or more of the available programs. A financial analysis tool facilitates the evaluation of the extension of credit or lending to any prospect on the filtered prospect list that seeks to participate in an available program associated with the selected agricultural input.

### BRIEF DESCRIPTION OF THE DRAWINGS

FIG. 1 is a block diagram of a system for marketing an agricultural input via electronic communications.

FIG. 2 is a flow chart of a method of marketing an agricultural input consistent with the block diagram of FIG. 1.

FIG. 3 is a block diagram that shows a marketing module in greater detail than FIG. 1.

FIG. 4 is a block diagram of a method of marketing an agricultural input consistent with the block diagram of FIG. 3.

FIG. 5 through FIG. 15, inclusive, are illustrative screen shots that may be displayed to a retailer or sponsor of an available program.

### DESCRIPTION OF THE PREFERRED EMBODIMENT

An available program may comprise a financial incentive program associated with a transaction or purchase of an agricultural input. Financial incentive programs include loans, rebates, discounts, promotional interest rates, zero percent interest rate financing plans, credit extensions, financing plans, and other lending or financial transactions. Agricultural inputs comprise seed, chemicals, fertilizer, insecticide, herbicide, fungicide, pesticide, food, medicine, or other inputs that are used in the production of agricultural products, food or in the raising of livestock.

As used herein, retailer means a seller, offeror, marketer, distributor, or supplier of an agricultural input. A sponsor or program sponsor means a lender, financial institution, seller, offeror marketer, distributor, or supplier that sponsors, promotes, or otherwise facilitates an available program or financial incentive program. A prospect means a potential customer, an actual customer, a grower, a producer, a farmer, a purchaser of an agricultural input, or an end user of the agricultural input; or a person or business that conducts a transaction associated with an agricultural input under an available program.

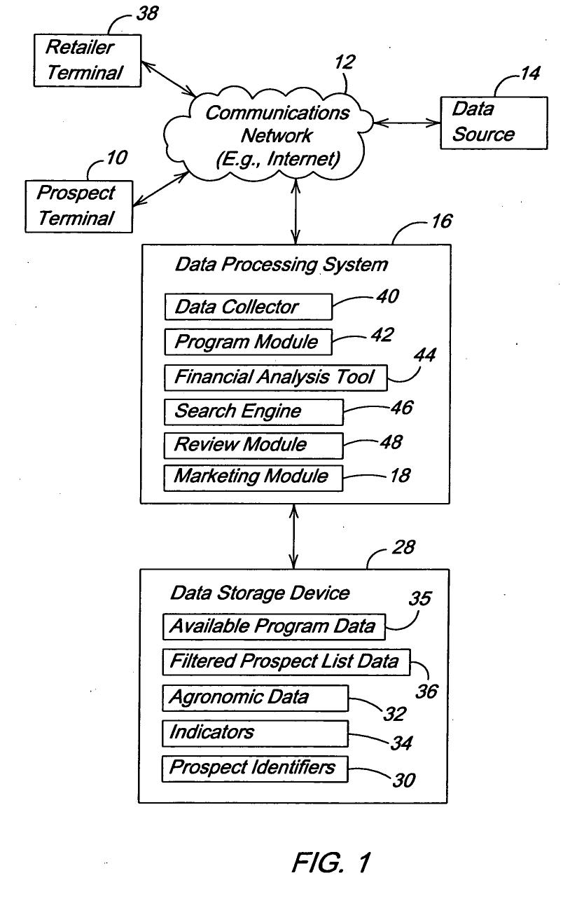

In FIG. 1, a system of marketing an agricultural input via electronic communications comprises a data processing system 16 that is coupled to a data storage device 28. The data processing system 16 is configured to communicate with one or more of the following via a communications network 12 (e.g., the Internet): a retailer terminal 38, a prospect terminal 10, and a data source 14.

The data processing system 16 comprises a data collector 40, a program module 42, a financial analysis tool 44, a search engine 46, a review module 48, and a marketing module 18. The data collector 40 obtains retailer information and product information associated with a corresponding retailer. For example, the data collector 40 may collect retailer information, product information, or both transmitted from a retailer terminal 38 over the communications network 12, or otherwise communicated. The retailer information comprises one or more of the following items: a retailer identifier, name, address, business structure, financial data, credit rating, and other data pertaining to the retailer. The product information means any of the following items that relate to any agricultural input: product identifier, product name, product description, product code, product quantity, product inventory, historical inventory, and planned prospective inventory. The data collector 40 is arranged to record acceptance of contractual terms and conditions by the retailer.

The program module 42 establishes available programs for the retailer based on at least one of the retailer information and product information. The financial analysis tool 44 supports the extension of credit or lending to at least one customer or prospect who seeks to participate in an available program. In one example, the financial analysis tool 44 may facilitate accessing a credit bureau to retrieve a credit report associated with the prospect. In another example, the financial analysis tool 44 comprises a viewer for viewing an electronic loan application that has been completed by a prospect or applicant. In yet another example, the financial analysis tool 44 provides statistical financial analyzer, a creditworthiness rating or a financial suitability rating for a corresponding prospect with reference to a reference group of prospects or customers. The reference group may grow the same or substantially similar crops as the prospect, have the same size or a comparable sized farm, be within a certain income range, or be located in the substantially the same geographic region, county, state, or country, for instance.

The marketing module 18 facilitates the selection and the marketing of an agricultural input. The identity or attributes of a particular agricultural input is selected from a library of candidate agricultural inputs. The marketing module 18 selects and markets to a filtered prospect list based upon one or more of the following indicators 34: estimated current purchase data for the agricultural input for a particular corresponding prospect, current crop risk analysis for a particular corresponding prospect, and a crop identifier for a particular corresponding prospect. The selected agricultural input is associated with one or more of the available programs.

In one embodiment, the marketing module 18 is arranged to identify potential prospects for the available programs based on a prospect list. The prospect list is filtered based on historical records of one or more agricultural inputs purchased by corresponding potential prospects.

The review module 48 supports a retailer's or user's decision on whether to process a transaction associated with a particular grower based on grower information and the provided financial analysis tool 44. The review module 48 may flag discrepancies on the electronic loan application, entries that are questionable or problematic, and entries that indicate the prospect has sufficient or deficient creditworthiness.

The data processing system 16 includes a search engine 46. The search engine 46 may support searching of various subject matter (e.g., stored in the data storage device 28) associated with available programs, grower information, or electronic loan applications in accordance with several illustrative examples. In a first illustrative example, the search engine 46 supports searching available programs by at least one of program sponsor, program type, crop type and product description. In a second illustrative example, the search engine 46 searches a grower based on grower information. Grower information or components thereof may be used as search criteria to retrieve grower records that substantially match the search criteria. Grower information may comprise agronomic data, demographic data, financial data, or background data on a grower or producer. In a third illustrative example, a search engine 46 searches an electronic loan application associated with a corresponding particular grower, and a review module 48 facilitates review of the loan application to determine whether or not to engage in a loan transaction with the corresponding particular grower.

The data storage device 28 may store any of the following types of data to support the data processing system 16: available program data 35, filtered prospect list data 36, agronomic data 32, indicators 34, and prospect identifiers 30. Agronomic data means demographic data associated with agricultural inputs, historical purchase data associated with agricultural inputs, historical cost of one or more crop inputs per land unit based on crop and geographic region, and current estimated cost of one or more crop inputs per land based on crop and geographic region. Indicators mean estimated current purchase data for the agricultural input for a particular corresponding prospect, current crop risk analysis for a particular corresponding prospect, and a crop identifier for a particular corresponding prospect. Prospect identifiers mean a name, number, a code, or another means of identification of a prospect.

The data source 14 may provide agronomic data 32 and prospect identifiers 30 to the data processing system 16 via the communications network 12. In turn, the data processing system 16 may forward the agronomic data 32 and prospect identifiers 30 to the data storage device 28 for archiving or subsequent retrieval. The data source 14 may represent a governmental database, an agency database, census data (e.g., U.S. Census, which is updated every decade), demographic data, survey data, marketing data, or a compilation of other data that is publicly available or commercially available.

A retailer terminal 38 may represent a computer, a data processor 20, or end user terminal associated with a retailer that offers or sells agricultural inputs, alone or in conjunction with available programs (e.g., financial incentive programs). Available programs may refer to, but are not limited to, financial incentive programs for a loan, extension of credit, rebate, interest rate reduction, or other financial measure associated with a transaction in an agricultural input.

A prospect terminal 10 may represent a computer, a data processor 20, or an end user terminal associated with a prospect that purchases or participates in a transaction associated with agricultural inputs, alone or in conjunction with an available program (e.g., financial incentive program). In practice, where the communications network comprises the Internet, the prospect terminal 10 may access the communications network 12 via an Internet Service Provider (not shown) interposed between the prospect terminal and the communications network 12.

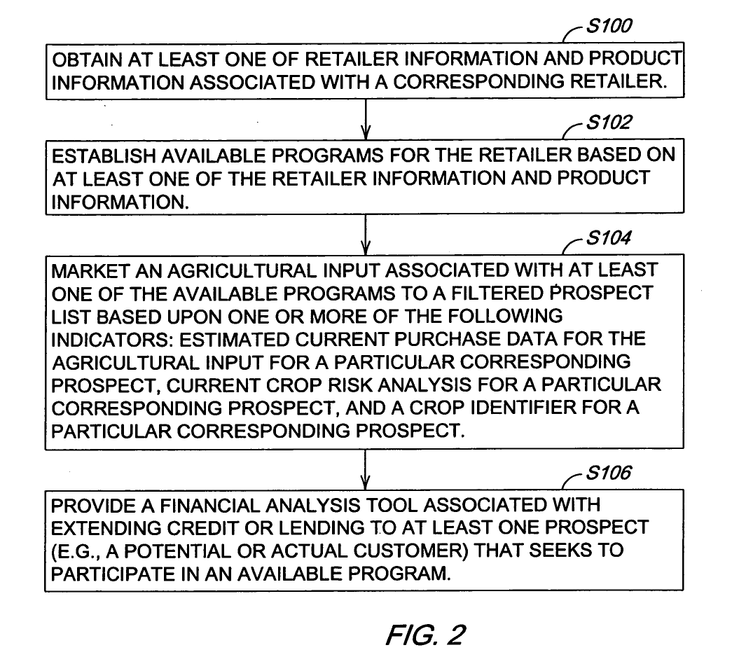

FIG. 2 illustrates a method of marketing an agricultural input via communications. The method of FIG. 2 begins in step S100.

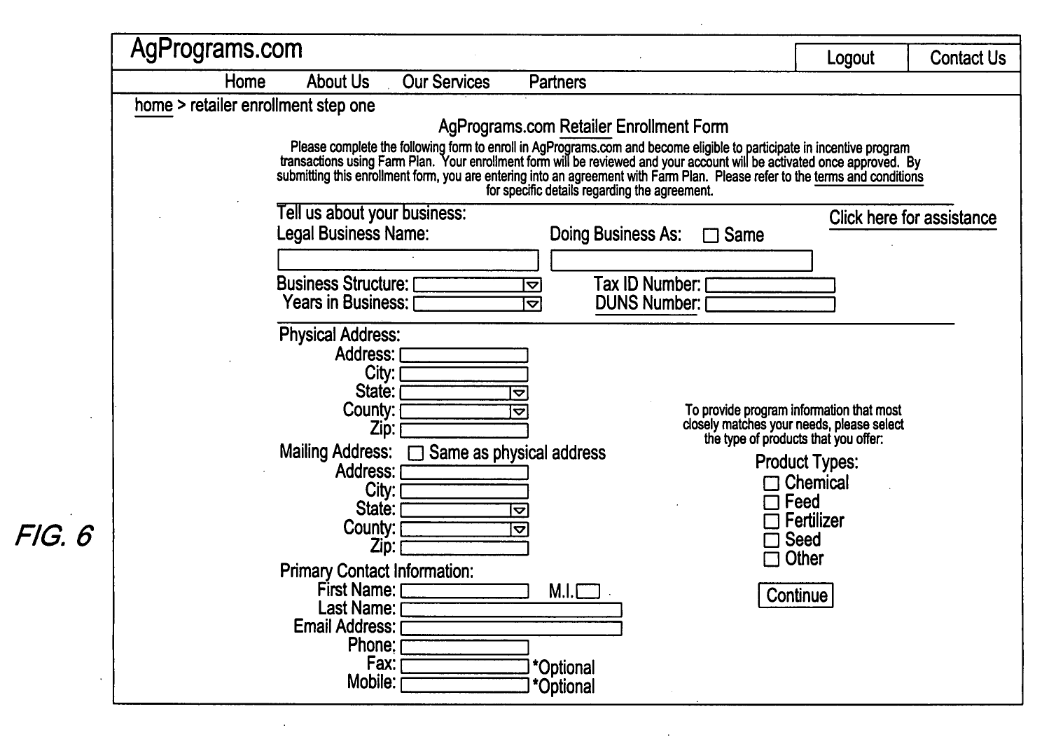

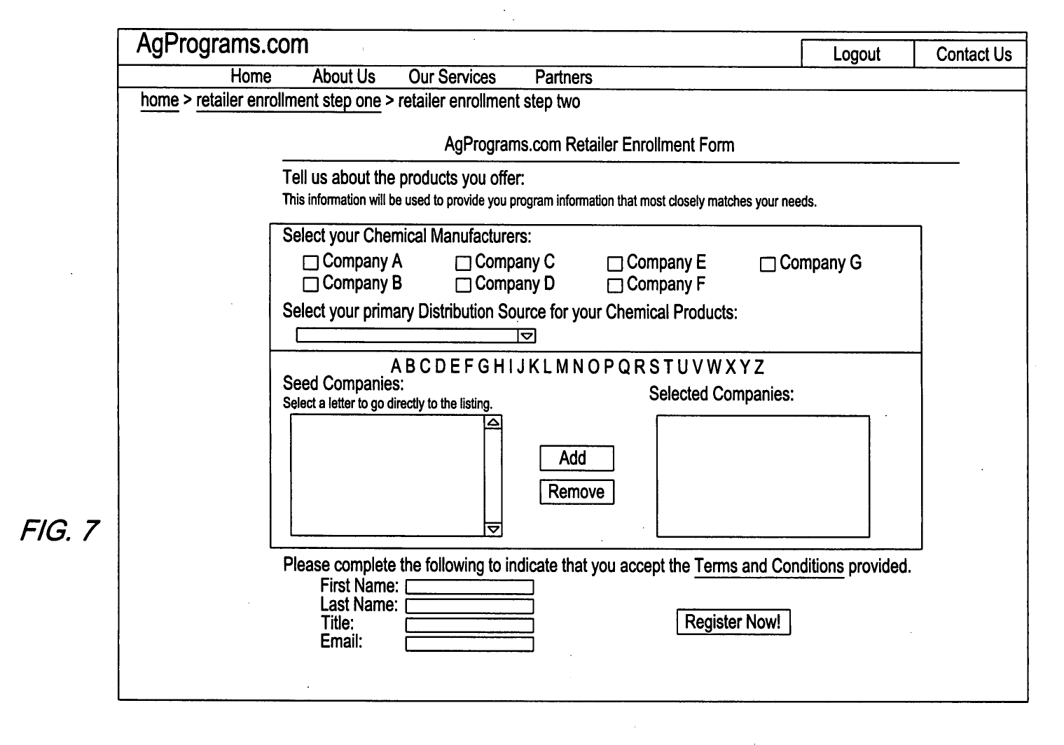

In step S100, a data collector 40 or data processing system 16 obtains retailer information and product information associated with a corresponding retailer. Retailer information and product information were previously defined in conjunction with the description of FIG. 1. The enrollment form of FIG. 6 and FIG. 7 may be used to obtain retailer information, product information, or both as described in step S100 of FIG. 2. The enrollment form is later described in greater detail in conjunction with FIG. 6 and FIG. 7.

In step S102, a program module 42 or the data processing system 16 establishes available programs for the retailer based on at least one of the retailer information and product information. Product information may include, but is not limited to, program sponsor or supplier of an agricultural input, available product types (e.g., insecticides) or product classification of the agricultural input, and applicable crop types (e.g., grain, corn or soybeans) for a corresponding agricultural input. The available programs may vary with the program sponsors, available product types or agricultural inputs, and available crop types that are made available to the retailer or the retailer decides to offer. For example, the retailer may be distributor of a particular line or brand of agricultural inputs or a retailer may have the greatest sales volume for a particular line or brand of agricultural inputs that effectively limits the available programs that the retailer promotes. A particular available program may be associated with an eligible list of eligible agricultural inputs, and agricultural inputs falling outside the eligible list are not subject to the benefits of the particular available program.

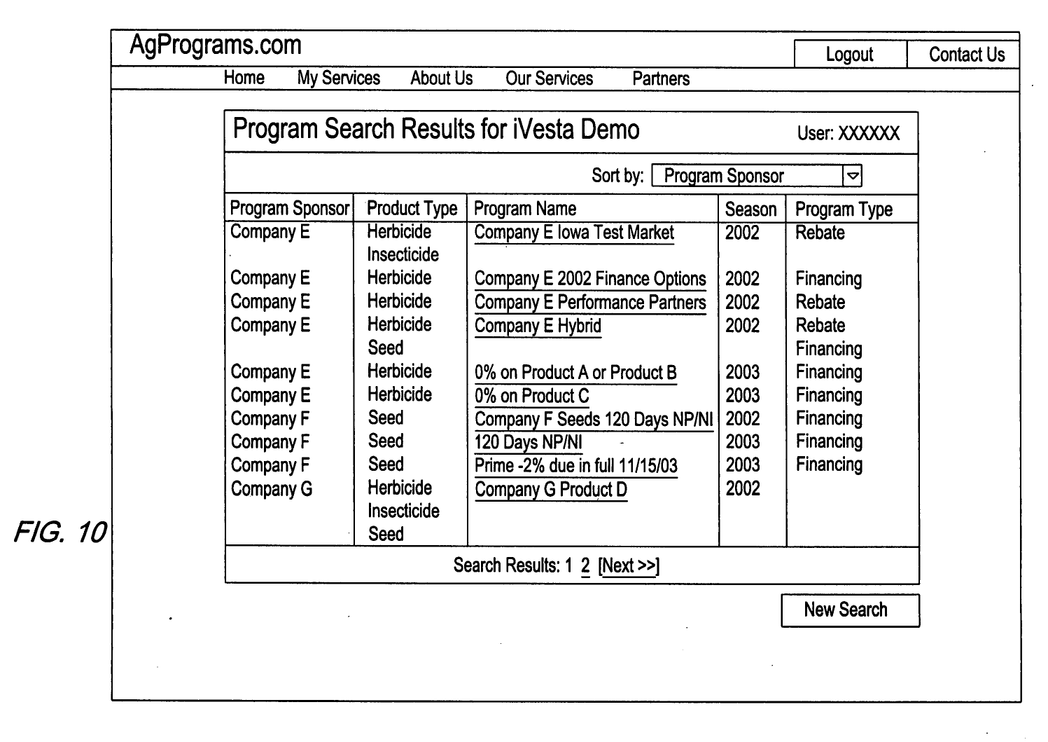

In step S104, a marketing module 18 facilitates marketing of an agricultural input (e.g., an eligible agricultural input) associated with at least one of the available programs to a filtered prospect list based upon one or more of the following indicators 34: estimated current purchase data for the agricultural input for a particular corresponding prospect, current crop risk analysis for a particular corresponding prospect, and a crop identifier for a particular corresponding prospect. For example, the marketing module 18 may identify potential prospects for the available programs based on a prospect list, where the prospect list is filtered based on historical records of one or more agricultural inputs purchased by corresponding potential prospects (or their predecessors in a farming business, land leasing, or land ownership). FIG. 10 is a screen representation of an illustrative list of established available programs that may be formed in accordance with step S104 of FIG. 2, or otherwise.

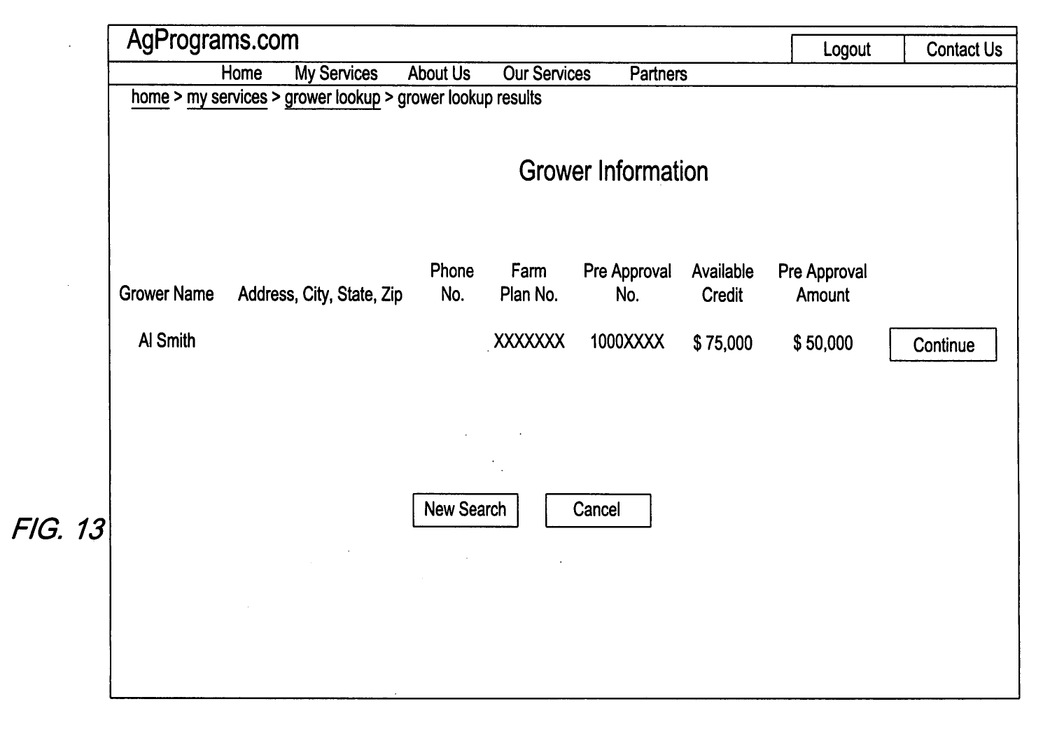

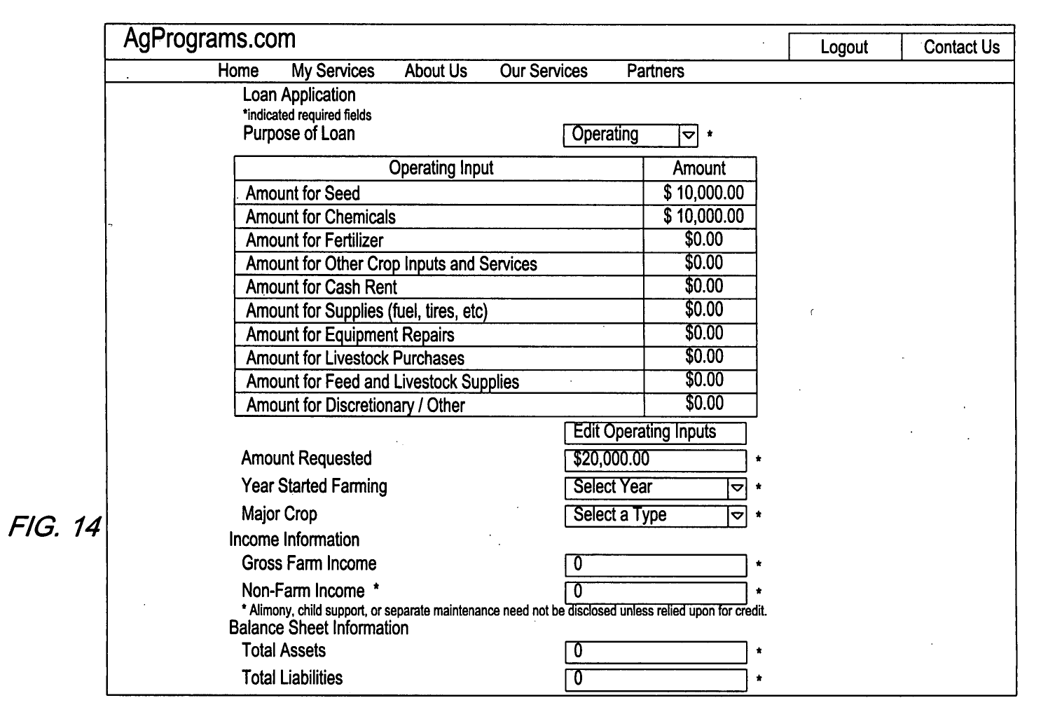

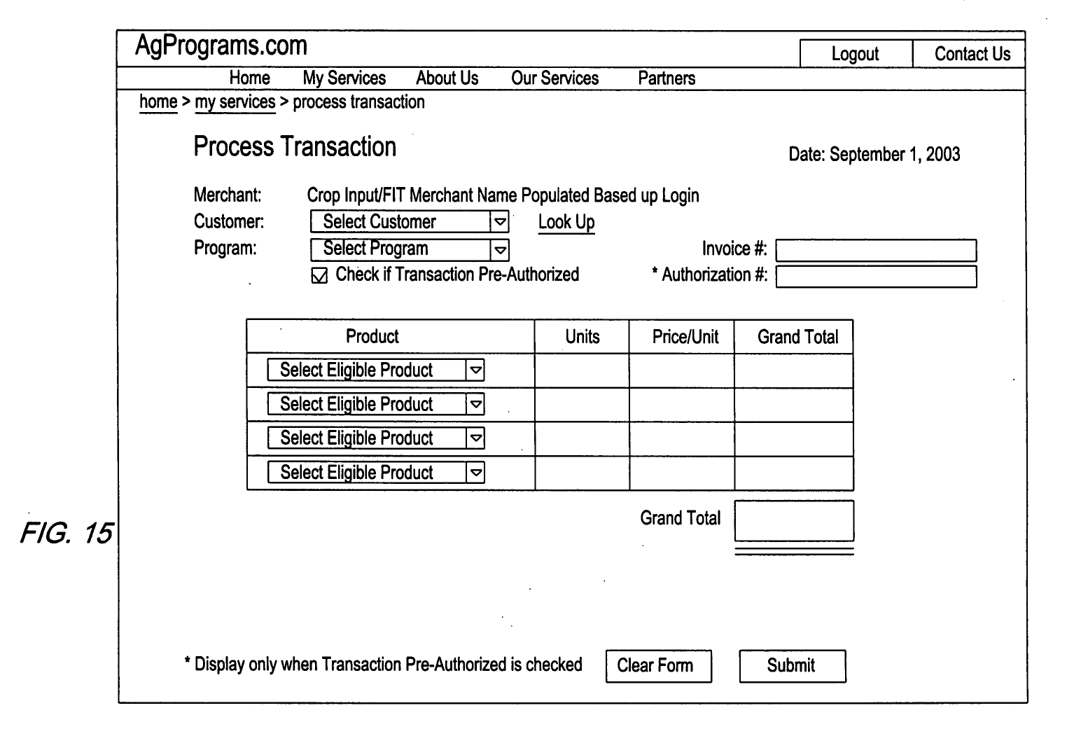

In step S106, a financial analysis tool 44 or the data processing system 16 provides a financial analysis tool 44 associated with extending credit or lending to at least one prospect on the filtered prospect list that seeks to participate in an available program. The financial analysis tool 44 facilitates deciding whether to process a transaction associated with a particular grower based on grower information. In one embodiment, the financial analysis tool 44 comprises a viewer for viewing one or more of the following: (1) an electronic loan application that has been completed by a prospect or applicant (e.g., such as the electronic loan application of FIG. 14), (2) grower information (e.g., such as the grower information displayed in FIG. 13), (3) proposed transactional parameters concerning the quantity and price of the agricultural inputs (e.g., such as the transactional parameters set forth in the screen displayed in FIG. 15).

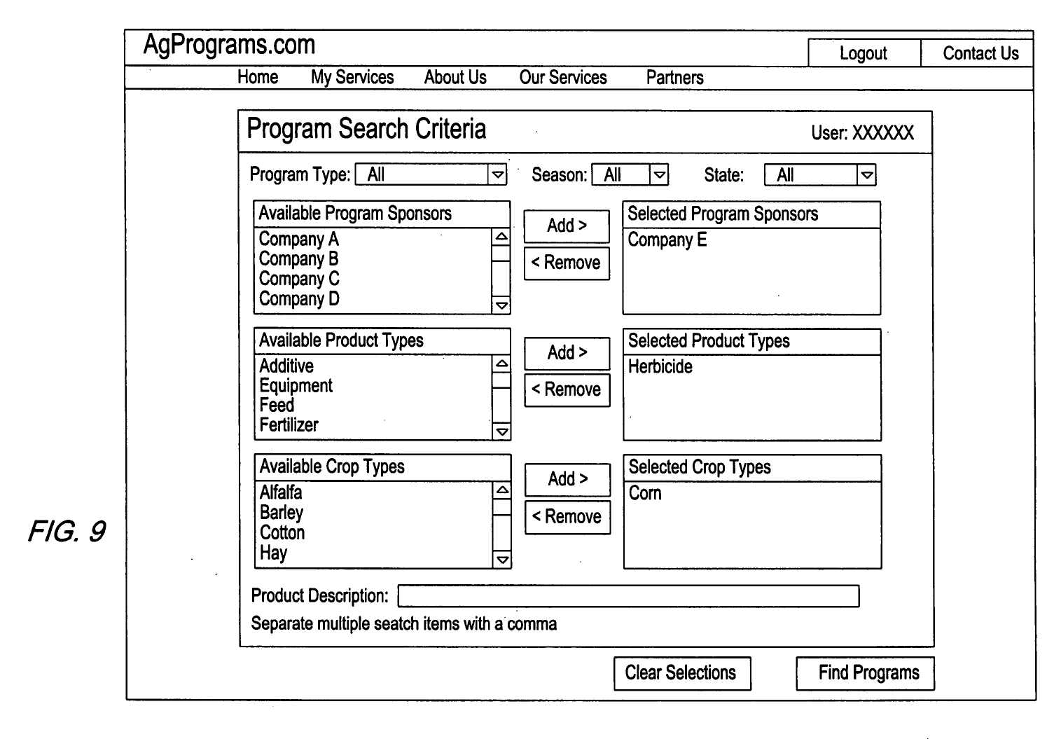

In one embodiment, the method of FIG. 2 further includes searching for desired data in accordance with one of the following examples. In accordance with a first example, via a retailer terminal 38 a particular retailer or user of the data processing system 16 searches for the available programs by at least one of program sponsor, product type, program type, crop type and product description. In conducting such a search for a particular available program or a group of particular available programs, the retailer may be presented with the search screen of FIG. 9, or another suitable screen, via the retailer terminal 38.

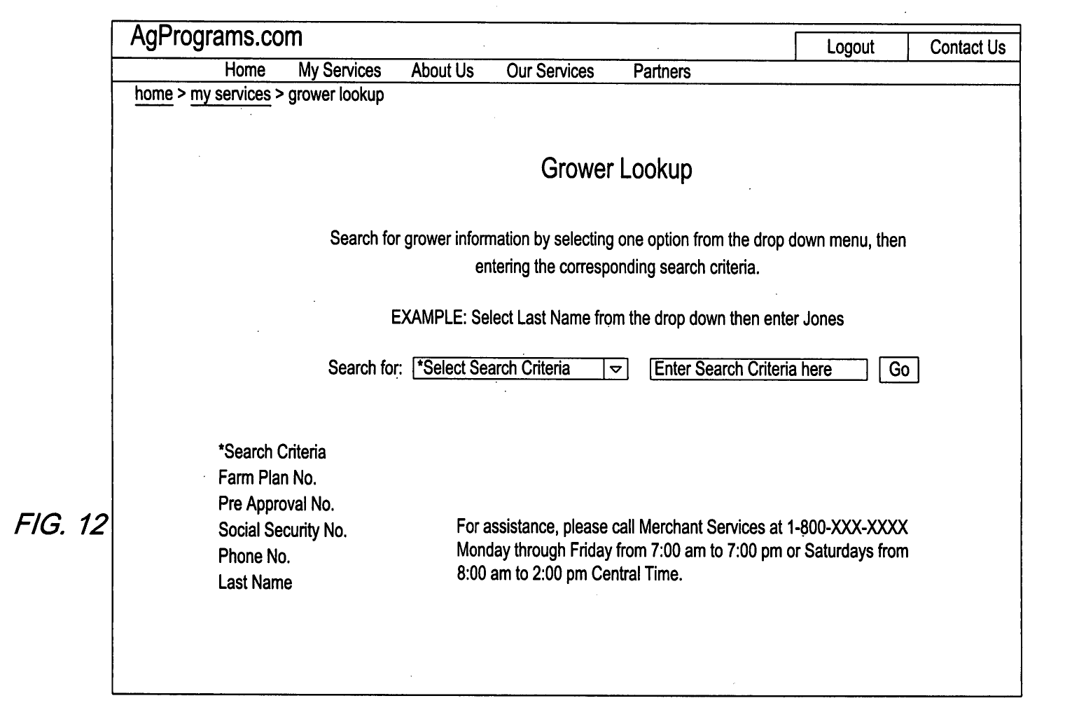

In accordance with a second example, via a retailer terminal 38, a particular retailer or user of the data searches for a grower based on grower information. In conducting such a search for a particular grower or a group of growers, the retailer may be presented with the search screen or grower lookup screen of FIG. 12, or another suitable screen, via the retailer terminal 38.

In accordance with a third example, via a retailer terminal 38, a particular retainer or user searches for a loan application associated with a corresponding particular grower and reviews the loan application to determine whether or not to engage in a loan transaction with the corresponding particular grower. FIG. 14 shows an illustrative example of a portion of a loan application for a particular grower.

In another embodiment, the method of FIG. 2 may further include the step of recording acceptance of contractual terms and conditions by the retailer. The contractual terms and conditions may be presented in accordance with the legal requirements for an enforceable click-wrap agreement, for example.

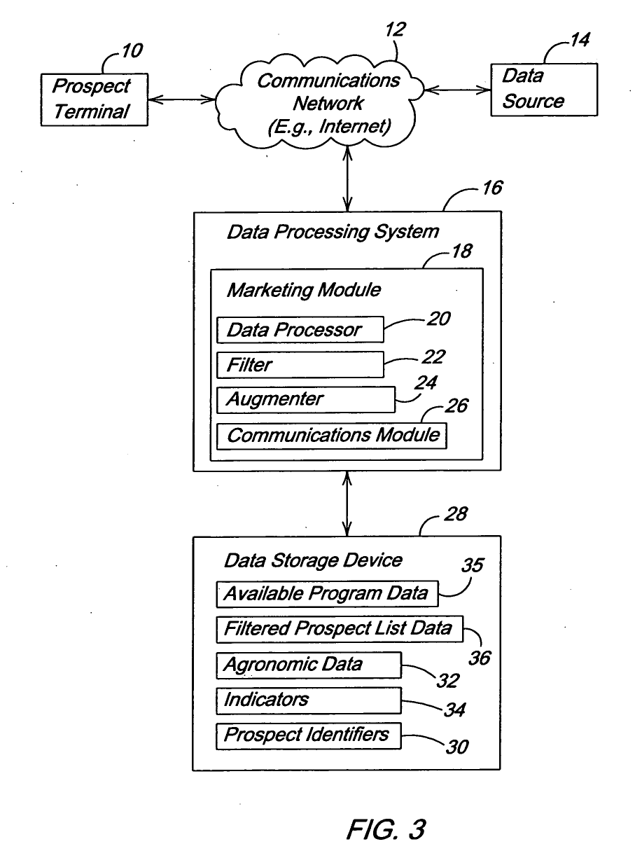

The configuration of FIG. 3 is similar to the configuration of FIG. 1, except FIG. 3 shows the marketing module 18 in greater detail. Like reference numbers in FIG. 1 and FIG. 3 indicate like elements.

The marketing module 18 comprises a data processor 20 associated with a filter 22. The filter 22 communicates with an augmenter 24. In turn, the augmenter 24 communicates with a communications module 26. The arrows that interconnect any of the data processor 20, filter 22, augmenter 24, and communications module 26 may indicate a logical data path, a physical data path, or both.

The data processor 20 prepares a raw prospect list of prospect identifiers 30 and at least one of the following agronomic data 32: demographic data associated with prospects, statistical data associated with agricultural inputs, historical purchase data associated with agricultural inputs, historical cost of one or more crop inputs per land unit (e.g., acre) based on crop and geographic region, and current estimated cost of one or more crop inputs per land based on crop and geographic region. The raw prospect list may be provided through or compiled from prior customer lists (e.g., of retailers, suppliers, sponsors, or lenders associated with agricultural inputs), marketing lists (e.g., of retailers, suppliers, sponsors, or lenders associated with agricultural inputs), surveys, questionnaires, census data, telephone directories, or publicly available sources.

The filter 22 filters the raw prospect list by the agronomic data 32 to obtain a filtered prospect list. For example, the filter 22 may reject members of the raw prospect list from being placed on the filtered prospect list, if the agronomic data or the financial data (e.g., credit report or credit bureau feedback) is deficient. The agronomic data is deficient if the agronomic data fails to meet or exceed a defined standard. A defined standard refers to a defined maximum, a defined minimum or a certain permissible range for a corresponding agronomic datum. The defined standards may be set with reference to business objectives of the retailer. For example, the retailer may wish to target growers in a defined geographic region (e.g., California, Colorado or New Jersey) with annual revenue that exceeds some defined annual minimum or annual production acreage that exceeds some defined minimum.

An augmenter 24 appends indicators 34 to the filtered prospect list based on an estimated current purchase data for agricultural inputs, current crop risk analysis, and crop identifier. A communications module 26 communicates a tailored message to one or more prospect identifiers 30 associated with the filtered prospect list based on the agronomic data 32 and appended indicators 34.

The augmenter 24 obtains information or feedback for the one or more prospect identifiers 30 to augment or revise at least one of the agronomic data 32, the appended indicators 34, and background data (e.g., prospect communication preferences) on the prospect identifier. For instance, the prospect may indicate that the prospect should not be called, should be called at a particular time, should receive information in writing, or other prospect communication preferences.

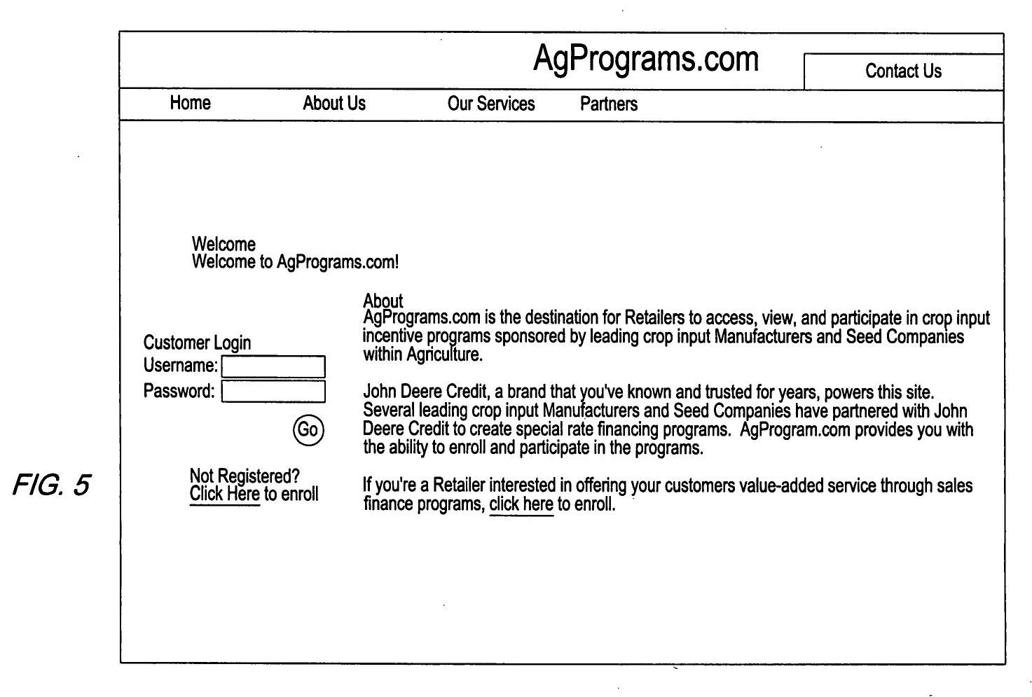

The communications module 26 may perform in accordance with various procedures. In accordance with a first procedure, the communications module 26 transmits the filtered prospect list and appended indicators 34 to a retailer or a sponsor of an agricultural financing program. In accordance with a second procedure, the communications module 26 communicates an availability of the agricultural financing program to a corresponding prospect identifier on the filtered prospect list based on the appended indicators 34. In accordance with a third procedure, the communications module 26 supports communications from one or more prospect identifiers 30 via prospect terminals 10 to facilitate establishing electronic access of prospects to offered financial programs associated with the purchase of corresponding agricultural inputs. The electronic access may be associated with an account for a corresponding prospect after the prospect enters requisite information. For example, the prospect may be required to register and enter requisite information to obtain a user name and password consistent with the log-on screen of FIG. 5.

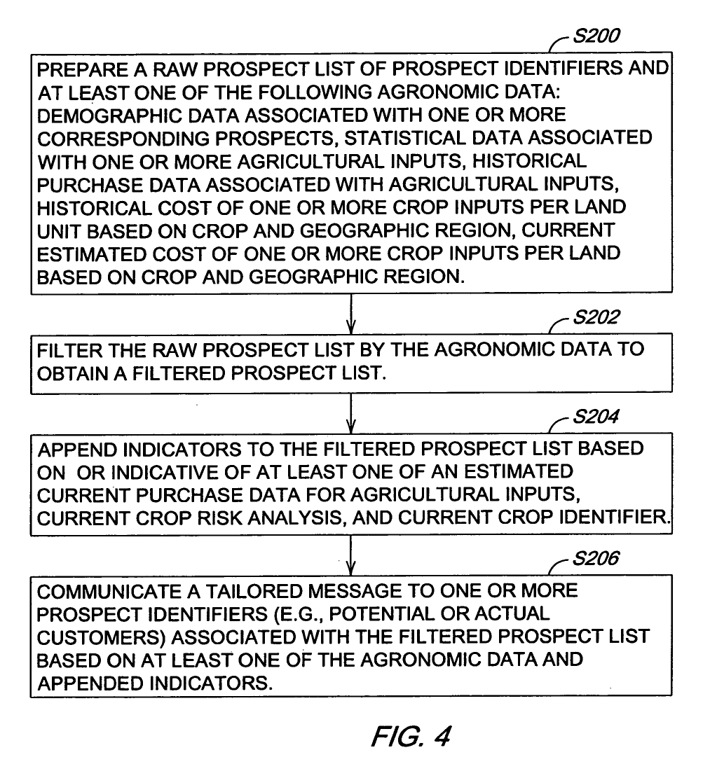

FIG. 4 represents a method of marketing an agricultural input via communications. The method of FIG. 4 begins in step S200.

In step S200, the data processor 20 or data processing system 16 prepares a raw prospect list of prospect identifiers 30 and at least one of the following agronomic data 32: demographic data associated with corresponding prospects, statistical data associated with agricultural inputs, historical purchase data associated with agricultural inputs, historical cost of one or more crop inputs per land unit (e.g., acre) based on crop and geographic region, and current estimated cost of one or more crop inputs per land based on crop and geographic region. Although raw prospect list data, demographic data, and agronomic data may be provided from the data source 14 via communications network 12, such data may be available on optical storage media, magnetic storage media, or in print for loading or entry into a user interface the data processing system 16. The prospect list data, demographic data, and agronomic data may contain any of the following types of data: proprietary data of the retailer, sponsor, lender or any third party licensor; publicly available data; commercially available data; governmental data, or compilations of any of the foregoing.

In step S202, the filter 22 or data processing system 16 filters the raw prospect list by the agronomic data 32 to obtain a filtered prospect list. For example, the filter 22 may reject certain prospects from the raw prospect list, if such certain prospects have undesired values that exceed a minimum parameter, a maximum parameter, or a parameter range for at least one of agronomic data 32, demographic data, or an indicator.

In step S204, the augmenter 24 or the data processing system 16 appends indicators 34 to the filtered prospect list based on or indicative of an estimated current purchase data for agricultural inputs, current crop risk analysis, and crop identifier. For example, the indicators may indicate an identifier of a corresponding agricultural input, a corresponding estimated quantity for the agricultural input, a respective crop identifier associated with the agricultural input, and a respective growing season descriptor to define estimated current purchase data. In practice, indicators may be provided as text, in tabular format, as a chart, or otherwise, for an entire plan of estimated agricultural inputs that may be of potential interest to the prospect.

In step S206, the communications module 26 or the data processing system 16 communicates a tailored message to one or more prospect identifiers 30 associated with the filtered prospect list based on the agronomic data 32 and appended indicators 34. The tailored message may comprise an e-mail message, a voice-mail message, an automated telephone call, a digitally encoded audio message, an electronic document, a letter, a direct mail advertisement, or otherwise. The communications of step S206 may be conducted in accordance with various cumulative or alternative procedures. Under a first procedure, the communications module 26 makes the filtered prospect list and appended indicators 34 available to a sponsor of an agricultural financing program and the sponsor may author, edit, revise, enter or select the tailored message for transmission to one or more prospects. In accordance with a second procedure, the communications module 26 communicates an availability of the agricultural financing program to a corresponding prospect identifier, prospect, or group of prospects on the filtered prospect list based on the appended indicators 34. In accordance with a third procedure, the communications module 26 supports communications from one or more prospect identifiers 30 to facilitate establishing electronic access to offered financial programs associated with the purchase of corresponding agricultural inputs.

After step S206, the communications module 26 may receive a response or communications from the prospect. The response or communication may provide the data processing system 16 the opportunity to obtain information or feedback for the one or more prospect identifiers 30 or prospects to augment or revise at least one of the agronomic data 32, the appended indicators 34, and background data (e.g., customer communication preferences) on the prospect identifier. Accordingly, the retailer may adjust future communications with the prospect based on the feedback.

FIG. 5 through FIG. 15, inclusive, show various screen displays from the perspective of a retailer (e.g., via a retailer terminal 38) or a sponsor applying any method of marketing an agricultural input via an incentive program and electronic communications. Any and all of the screen displays of FIG. 5 through FIG. 15 may be used in conjunction with any of the steps of FIG. 2, FIG. 4 or any other method that falls within the scope of the claims. Any of the screens of FIG. 5 through FIG. 15, inclusive, may be displayed via the retailer terminal 38, for example.

FIG. 5 shows a log-on screen display from the perspective of a retailer or sponsor of an available program (e.g., a financial incentive program). The retailer is invited to register to enroll in the register of authorized retailers. If the retailer logs in by entering an appropriate user name and password, the retailer may be directed to the screen displayed in FIG. 6 or a similar screen.

The screen of FIG. 6 displays an enrollment form (e.g., an electronic document) for the retailer to enroll as a distributor, reseller or offeror of financial incentive programs (e.g., incentive programs of AgPrograms.com). The retailer must complete the enrollment form of FIG. 6 or a similar form to become eligible to participate in the promotion of incentive program and in incentive program transactions with prospects, in accordance with a contractual agreement. For instance, the contractual agreement may be between the retailer and the manager of electronic resources associated with the incentive programs. By submitting the enrollment form to the manager (e.g., Farm Plan), the retailer is making an offer that the manager can accept as a contractual agreement. The terms and conditions of the agreement may be viewed, printed or downloaded prior to the submission by the retailer. The enrollment form will be reviewed by the manager of the electronic access for the incentive program transactions. If the contents of the enrollment form are acceptable, the retailer's account will be activated to access electronic resources for the offering of or transactions in incentive program transactions for prospects, growers, or other customers, consistent with the agreement, which may be modified from time to time by mutual assent in exchange for the retailer's continued electronic access to the electronic resources for the incentive programs.

Although the enrollment form may include virtually any type of retailer information that would be useful to the manager in determining whether to grant access to the retailer to the incentive program transactions, in the configuration shown in FIG. 6, the enrollment form requests one or more of the following information concerning the retailer: legal business name, doing-business-as data, business structure, years in business, tax identification number, DUNS number (i.e., a number assigned by Dun & Bradstreet to uniquely identify a business and associated financial records), physical address, mailing address, e-mail address, primary contact information, phone number, fax number, and product types. The enrollment form of FIG. 6 may be used to obtain retailer information, product information, or both, as described in step S100 of FIG. 2.

Further, as shown in the illustrative example of FIG. 7, the enrollment form requires supplier information and product information about agricultural inputs or other products offered, distributed or sold by the retailer. For example, the retailer may list the chemical manufacturers that supply agricultural inputs such as fertilizer, insecticides, pesticides, fungicides, and herbicides and the retailer may list seed providers. A select list of manufacturers or suppliers of agricultural inputs may appear as a check list as shown in FIG. 7. The suppliers or list of agricultural inputs may be selected from a menu or library of possible choices or manually entered via a user interface of the retailer terminal 38. In one embodiment, the retailer may select a primary source for certain agricultural inputs. The primary source would represent the retailer's preferential choice for distribution or offering of certain corresponding agricultural products for business reasons, contractual reasons, or any other lawful purpose. In another embodiment, the retailer may select a primary source, a secondary source, and a tertiary source for identified agricultural inputs.

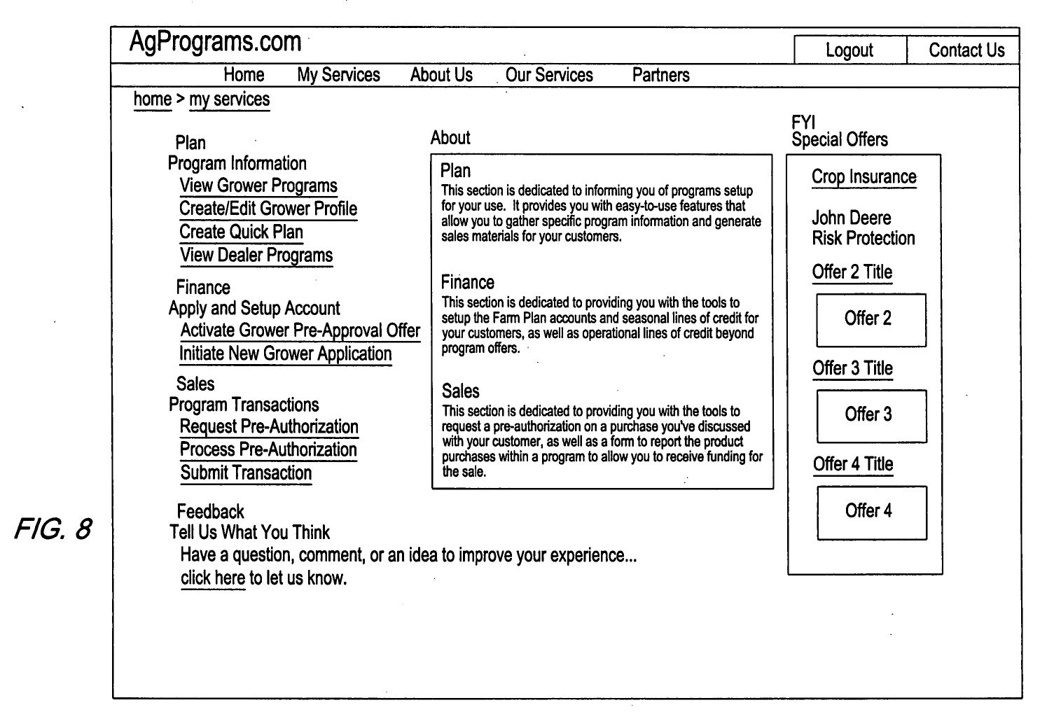

FIG. 8 represents a menu screen that is displayed to a retailer that has completed an enrollment form that is accepted by the manager. The menu screen of FIG. 8 is displayed for a retailer account that has been granted access to electronic resources for conducting transactions for financial incentive programs. For example, the electronic resources include program information about financial incentive programs, establishing and administering prospect, grower or customer accounts, and conducting program transactions.

The menu screen of FIG. 8 allows a retailer to select one or more of the following selections under program information: view grower programs, create/edit grower profile (or create/edit prospect profile), create quick plan, and view dealer programs. The program information selection informs a retailer about the parameters, availability, and participation requirements for various available incentive programs. The retailer may search for incentive programs with particular parameters or generate sales materials for particular incentive programs, particular customers, or both.

The menu screen of FIG. 8 allows a retailer to select one or more of the following menu selections under the heading of “apply and set up account”: activate grower pre-approval offer and initiate new grower application. From the “apply-and set-up-account” selection, a retailer may access tools to set up customer accounts for prospects, arrange seasonal lines of credit for customers or prospects, arrange operational lines of credit within the terms of one or more incentive programs, and otherwise facilitate a prospect's participation in an incentive program. Further, the retailer may be permitted to engage in other financial transactions, to offer loans to prospects that are not in conformity with any incentive program, to offer crop risk insurance (e.g., special offers) or to offer other financial products, as lawfully permitted, and authorized by the manager and other applicable parties.

The menu screen of FIG. 8 allows a retailer to select one or more of the following menu selections under the heading of program transactions: request pre-authorization, process pre-authorization, and submit transaction. The program transaction selection provides the retailer with access to tools for requesting pre-authorization on a defined purchase (e.g., a prospective planned purchase) or another transaction of a customer or prospect. The program transaction selection also supports a retailer's communication with the sponsor of a program such that the retailer receives funding for a sale pursuant to an incentive program, facilitates clearance and settlement (e.g., loan disbursement or loan discharge) of a transaction incident to an incentive program, or conducts another transaction between the sponsor and the retailer that supports the incentive program.

FIG. 9 is an illustrative example of a screen that is displayed to a retailer in response to a retailer selecting view grower programs in FIG. 8. Alternately, a retailer may reach the screen of FIG. 9 by entering a command or selecting a menu button or selection that indicates search available programs. Although the retailer may search available programs via available program sponsors (e.g., names of available program sponsors), available product types, available crop types, or other product descriptions, in an alternate embodiment the retailer may search for available programs using other criteria or attributes (e.g., effective dates, date ranges, geographic availability, terms, interest rate ranges, or interest rates) associated with the available programs. The available product types may include at least one of an additive, chemical, equipment, feed, fertilizer, insecticide, herbicide, plant hormone, growth hormone, and fungicide. The available crop types may include at least one of alfalfa, barley, beans, cotton, corn, grain, hay, oilseeds, soybeans, sorghum, sugar cane, sugar beets, tobacco, wheat, edible crops, fiber crops, and inedible crops.

FIG. 10 is an illustrative example of search results that are provided in response to a retailer entering a search request in accordance with the screen of FIG. 9, for example. As shown, the program search results display one or more available programs that meet a search criteria. The search results may provide the following information in tabular, textual, or another format: program sponsor, product type, program name, season or program type. The product type may include a herbicide an insecticide, seed, or otherwise, for example. The program type may represent a rebate, financing program, a financial incentive program or another type of available program as previously described herein.

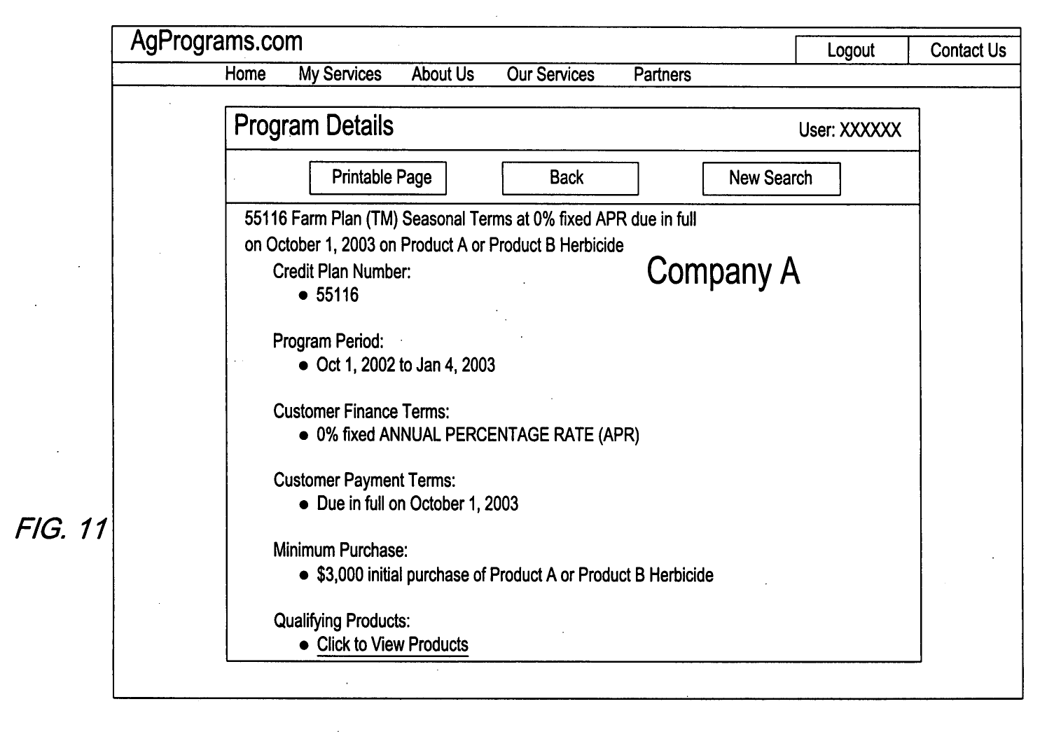

FIG. 11 represents an illustrative display of a single incentive program selected from the group of search results shown in FIG. 10. In one embodiment, the search results of FIG. 10 have a hypertext link associated with each incentive program that provides access to a program screen with detailed information about the incentive program. The program screen of FIG. 11 displays one or more of the following items of information: incentive program name or identifier, interest rate, principal and interest due date, program period, customer finance terms, minimum purchase, and qualifying product identifiers. The screen may include hypertext links or reference to more detailed information about a corresponding available program displayed.

FIG. 12 is an illustrative example of screen that supports a retailer's searching for a prospect (e.g., grower or customer) with particular attributes or characteristics associated with a search criteria. Although any attribute of a grower, customer or prospect may be used as a search criteria, in one embodiment the search criteria includes at least one of a last name of a grower or prospect, a name of grower or prospect, a plan number, a pre-approval number, social security number, a tax identification number, and a phone number.

FIG. 13 is an illustrative example of a screen that is displayed in response to the entry of a search criteria in FIG. 12. The retailer may view grower information displayed in tabular or textual format, for example. The grower information may include at least one of a grower name or prospect name, address, phone number, pre-approval number (e.g., credit authorization number), available credit amount, pre-approval amount, transaction amount, and transaction identifier. The grower information screen of FIG. 13 may allow a retailer to return to the grower search screen of FIG. 12 by activating a push button labeled new search, for example.

FIG. 14 is an illustrative example of a retailer's view of a loan application (e.g., an electronic document) of a corresponding particular grower, prospect or customer. The retailer may view the loan application displayed as FIG. 14 (e.g., via the retailer terminal 38) to determine whether to conduct a transaction with the particular grower or whether to obtain a credit authorization or pre-approval authorization. The loan application may contain a list of agricultural inputs (e.g., operating inputs) and corresponding fiscal amounts. The list of agricultural inputs and monetary amounts may be displayed in a tabular, textual, or another data format. As shown in FIG. 14, the agricultural inputs include seed, chemicals, fertilizer, other crop inputs and services, amount for cash rent, suppliers for equipment, equipment repairs, livestock purchases, feed and livestock supplies, and discretionary or other agricultural inputs. The loan application may include background data, agronomic data, or demographic data about the prospect such as the year started farming, major crop, income information, gross farm income, non-farm income, balance sheet information, total assets, and total liabilities.

FIG. 15 is an illustrative example of a retailer's view of a process transaction screen. The process transaction screen allows a retailer to select a loan application of a particular grower or prospect and execute a transaction. The process transaction screen may require a retailer to enter or select one or more of the following: a merchant identifier for an agricultural input that forms the subject matter of the transaction or purchase; a prospect or customer identifier, a prospect or customer name, a program identifier, a program name, an invoice number or code; a credit authorization number or code, a pre-authorized transaction number or code; one or more product identifiers that form the subject matter of the transaction; units or quantity of the corresponding product identifiers per unit price of the product identifiers, and the extended cost of the product identifiers. If the retailer approves of the transaction request and/or loan application submitted by the grower or prospect, the retailer may execute or approve the transaction by activating the submit button. If the retailer wishes to edit or revise the transaction (e.g., to reduce the units or quantity of corresponding agricultural inputs) to reduce the overall price of the transaction to an acceptable level of risk for the relative level of creditworthiness of the grower, the retailer may revise the transaction prior to approval or execution by editing or clearing the form.

The method and system of the invention promotes increased awareness of various incentive programs by retailers and growers. Retailers may be able to sell greater quantities of agricultural inputs with the ready availability of financing to qualified prospects or growers. The filtered prospect list may be pre-approved for creditworthiness to reduce the risks to retailers and program sponsors. Growers or prospects that lack the desired level of creditworthiness are readily and efficiently screened by minimal expenditure of human resources to reduce costs. The retailer may validate the purchases of agricultural inputs to assure that such transactions present minimal financial risk. Accordingly, the retailer and the sponsor may experience reduced transaction costs and administration costs associated with administering incentive programs because of electronic communications and resources.

Having described the preferred embodiment, it will become apparent that various modifications can be made without departing from the scope of the invention as defined in the accompanying claims.

What is claimed is:

1. A method of marketing an agricultural input via communications, the method comprising:
obtaining retailer information and product information associated with a corresponding retailer;
establishing available programs for the retailer based on the retailer information and product information;
marketing an agricultural input associated with at least one of the available programs to a filtered prospect list based upon one or more of the following indicators: estimated current purchase data for the agricultural input for a particular corresponding prospect, current crop risk analysis for a particular corresponding prospect, and a crop identifier for a particular corresponding prospect; and
providing a financial analysis tool associated with extending credit or lending to at least one prospect on the filtered prospect list that seeks to participate in an available program.

2. The method according to claim 1 further comprising:
searching the available programs by at least one of program sponsor, program type, crop type and product description.

3. The method according to claim 1 further comprising:
searching for a grower on the filtered prospect list based on grower information.

4. The method according to claim 1 further comprising:
searching for an electronic loan application associated with a corresponding particular grower; and
reviewing the electronic loan application to determine whether or not to engage in a loan transaction with the corresponding particular grower.

5. The method according to claim 1 further comprising:
deciding whether to process a transaction associated with a particular grower based on grower information and the provided financial analysis tool.

6. The method according to claim 1 further comprising:
identifying potential prospects for the available programs based on a raw prospect list, the raw prospect list filtered to provide the filtered product list based on historical records of one or more agricultural inputs purchased by corresponding potential prospects.

7. The method according to claim 1 further comprising:
recording acceptance of contractual terms and conditions by the retailer to support a contractual agreement between a manager of electronic resources for the available programs and the retailer.

8. A method of marketing an agricultural input via communications, the method comprising:
preparing a raw prospect list of prospect identifiers and at least one of the following agronomic data: demographic data associated with corresponding prospects, statistical data associated with one or more corresponding agricultural inputs, historical purchase data associated with one or more agricultural inputs, historical cost of one or more crop inputs per land unit based on crop and geographic region, current estimated cost of one or more crop inputs per land based on crop and geographic region;
filtering the raw prospect list by the agronomic data to obtain a filtered prospect list;
appending indicators to the filtered prospect list based on an estimated current purchase data for agricultural inputs, current crop risk analysis, and crop identifier; and
communicating a tailored message to one or more prospect identifiers associated with the filtered prospect list based on the agronomic data and appended indicators.

9. The method according to claim 8 further comprising:
obtaining information or feedback for the one or more prospect identifiers to augment or revise at least one of the agronomic data, the appended indicators, and background data on the prospect identifier.

10. The method according to claim 8 further comprising:
making the filtered prospect list and appended indicators available to at least one of the retailer and the sponsor of an available program.

11. The method according to claim 8 further comprising:
communicating an availability of the available program to a corresponding prospect identifier on the filtered prospect list based on the appended indicators.

12. The method according to claim 11 further comprising:
supporting communications from one or more prospect identifiers to facilitate establishing electronic access to offered available programs associated with the purchase of corresponding agricultural inputs.

13. The method according to claim 12 wherein the supporting communications are accomplished by establishing an account for a corresponding prospect after the prospect enters requisite information.

14. A system of marketing an agricultural input via communications, the system comprising:
a data collector for obtaining at least one of retailer information and product information associated with a corresponding retailer;
a program module for establishing available programs for the retailer based on at least one of the retailer information and product information; and
a marketing module for marketing an agricultural input associated with at least one of the available programs to a filtered prospect list based upon one or more of the following indicators: estimated current purchase data for the agricultural input for a particular corresponding prospect, current crop risk analysis for a particular corresponding prospect, and a crop identifier for a particular corresponding prospect; and
a financial analysis tool associated with extending credit or lending to at least one customer seeking to participate in an available program.

15. The system according to claim 14 further comprising:
a search engine for searching available programs by at least one of program sponsor, program type, crop type and product description.

16. The system according to claim 14 further comprising:
a search engine for searching at least one of a grower and a prospect based on grower information.

17. The system according to claim 14 further comprising:
a search engine for searching an electronic loan application associated with a corresponding particular grower; and
a review module for reviewing the electronic loan application to determine whether or not to engage in a loan transaction with the corresponding particular grower.

18. The system according to claim 14 further comprising:
a review module supporting a decision on whether to process a transaction associated with a particular grower based on grower information and the provided financial analysis tool.

19. The system according to claim 14 wherein the marketing module is arranged to identify potential prospects for the available programs based on a raw prospect list, the raw prospect list filtered to yield the filtered prospect list based on historical records of one or more agricultural inputs purchased by corresponding potential prospects.

20. The system according to claim 14 wherein the collector is arranged to record acceptance of contractual terms and conditions by the retailer.

21. A system of marketing an agricultural input via communications, the system comprising:
a data processor for preparing a raw prospect list of prospect identifiers and at least one of the following agronomic data: demographic data associated with corresponding prospects, statistical data associated with corresponding agricultural inputs, historical purchase data associated with agricultural inputs, historical cost of one or more crop inputs per land unit based on crop and geographic region, current estimated cost of one or more crop inputs per land based on crop and geographic region;
a filter for filtering the raw prospect list by the agronomic data to obtain a filtered prospect list;
an augmenter for appending indicators to the filtered prospect list based on an estimated current purchase data for agricultural inputs, current crop risk analysis, and crop identifier; and
a communications module for communicating a tailored message to one or more prospect identifiers associated with the filtered prospect list based on the agronomic data and appended indicators.

22. The system according to claim 21 wherein the augmenter obtains information or feedback for the one or more prospect identifiers to augment or revise at least one of the agronomic data, the appended indicators, and background data on the prospect identifier.

23. The system according to claim 21 wherein the communications module transmits the filtered prospect list and appended indicators to a sponsor of an agricultural financing program.

24. The system according to claim 21 wherein the communications module communicates an availability of an available program to a corresponding prospect identifier on the filtered prospect list based on the appended indicators.

25. The system according to claim 24 wherein the communications module supports communications from one or more prospect identifiers to facilitate establishing electronic access to offered financial programs associated with the purchase of corresponding agricultural inputs.
